(19) United States
(12) Patent Application Publication
(10) Pub. No.: US 2026/0343435 A1
(43) Pub. Date: Oct. 29, 2026

(54) EXTENDING RADIO FREQUENCY (RF) RANGE AT FRONT END MODULE (FEM)

(71) Applicant: Apple Inc., Cupertino, CA (US)

(72) Inventors: Mohammad B. Vahid Far, Los Altos, CA (US); Kevin Bastin, Fremont, CA (US); Yilin Feng, San Jose, CA (US)

(73) Assignee: Apple Inc., Cupertino, CA (US)

(21) Appl. No.: 19/189,102

(22) Filed: Apr. 24, 2025

(51) Int. Cl. H04W 52/36; H04L 1/00

(52) U.S. Cl. CPC H04W 52/367; H04L 1/0003; H04W 52/362

(57) ABSTRACT

The present disclosure relates to extending the RF range of a wireless radio based on an architecture and control logic of a FEM. In an example, a digital transmitter is implemented and includes processing circuitry, an antenna, and the FEM. The FEM provides a dynamic range for signal transmission, where this range is larger than that of the processing circuitry. To do so, the FEM includes a plurality of PA stages and stores related control logic. Each of the stages includes a PA that can have an adjustable gain. The control logic can define different transmission modes corresponding to different PA stage configurations. Depending on a number of transmission parameters, such as a target power output for the FEM and/or an MCS used by the processing circuit, one of the transmission modes is used to enable the corresponding PA stage configuration in the signal transmission.

### BACKGROUND

A device can include a radio frequency (RF) radio that enables communications with other devices. The communications can include transmitting a signal by a transmitter of the radio. Such a signal is typically amplified as part of the RF transmit chain.

### BRIEF DESCRIPTION OF THE DRAWINGS

FIG. 1 illustrates an example of a device that includes a digital transmitter, in accordance with various embodiments.

FIG. 2 illustrates an example of attenuator circuitries that can be used in a digital transmitter, in accordance with various embodiments.

FIG. 3 illustrates an example of a front end module (FEM) circuitry of a digital transmitter, where the FEM includes a plurality of power amplifier (PA) stages, in accordance with various embodiments.

FIG. 4 illustrates an example of a FEM circuitry of a digital transmitter, where the FEM includes a plurality of attenuator stages, in accordance with various embodiments.

FIG. 5 illustrates an example of a plot of current as a function of power, where the plot is usable to define different transmission modes of a FEM, in accordance with various embodiments, in accordance with various embodiments.

FIG. 6 illustrates an example of power segments and gain steps usable to control a transmission configuration, in accordance with various embodiments.

FIG. 7 illustrates another example of power segments and gain steps usable to control a transmission configuration, in accordance with various embodiments.

FIG. 8 illustrates another example of power segments and gain steps based on modulation coding schemes (MCSs), in accordance with various embodiments.

FIG. 9 illustrates another example of power segments and gain steps based on temperature, in accordance with various embodiments.

FIG. 10 illustrates yet another example of power segments and gain steps based on temperature, in accordance with various embodiments.

FIG. 11 illustrates an example of an operational flow/algorithmic structure for controlling a FEM, in accordance with various embodiments.

FIG. 12 illustrates an example of an operational flow/algorithmic structure for configuring components of a FEM, in accordance with various embodiments.

FIG. 13 illustrates a device, in accordance with some embodiments.

### DETAILED DESCRIPTION

The present disclosure relates to, among other things, extending the radio frequency (RF) range of a wireless radio based on an architecture and control logic of a front end module (FEM) of the wireless radio. In an example, the wireless radio includes a digital transmitter that, in turn, includes processing circuitry (e.g., a system-on-chip (SoC) that processes a baseband signal for transmission), an antenna, and the FEM. The FEM is coupled with the processing circuitry and the antenna and provides a dynamic range for signal transmission, where this dynamic range is larger than that of the processing circuitry. To do so, the FEM includes a plurality of power amplifier (PA) stages (also referred to as a multi-stage PA topology, or an external PA (ePA)) and stores related control logic. Each of the stages includes a PA that can have an adjustable gain. The control logic can define different transmission modes (also referred to as FEM modes) corresponding to different configurations of the multi-PA stage topology (e.g., one configuration having one PA stage switched ON, another configuration having that PA stage switched OFF, and yet another configuration in which the PA stage is switched ON and its gain is adjusted). Depending on a number of transmission parameters, such as a target power output for the FEM and/or a modulation coding scheme (MCS) used by the processing circuit, one of the transmission modes is used (e.g., selected by the processing circuitry and indicated to the FEM via a command). The configuration of the multi-stage PA topology (e.g., switching ON/OFF particular PA stages and/or adjusting the gain(s) of a particular PA (s)) is controlled according to the transmission mode.

In addition to the multi-stage PA topology, the FEM can also include a plurality of attenuator stages (also referred to as a multi-stage attenuator topology, or an external attenuator). Such stages can likewise be controlled based on the number of transmission parameters. The transmission modes can enable gain adjustments to extend the dynamic range while also mitigating signal linearity related challenges.

The transmission modes can be defined for different power range segments and can enable a gain variation within each power segment. These definitions can account not only for the MCS but for other parameters, such as temperature and/or dynamic range of the processing circuitry.

Depending on the device and the wireless communication (e.g., one using WiFi), time constraints can exist, where these constraints can limit the available time to configure the FEM. In the example of WiFi, the inter-frame spacing can be a few microseconds, leaving less than a couple of microseconds to configure the FEM between two frames. To support such time constraints, a Register 0 (Reg0) implementation can be used at the FEM. In this implementation, the processing circuitry (e.g., SoC) can send a single command to set the configuration of the multi-stage PA topology and the multi-stage attenuator topology. First information in the command can correspond to a first entry in Reg0, and remaining information in the command can correspond to a second entry in Reg0. The first entry corresponds to a configuration of the multi-stage PA topology, whereas the second entry corresponds to a configuration of the multi-stage attenuator topology. In this way, from a single command of the processing circuitry, the FEM can control both topologies within the time constraints. Although using Reg0 is described, other memory implementations are possible where Reg0 is used in combination with one or more other registers.

The above features (e.g., multi-stage PA topology, multi-stage attenuator topology, transmission mode definitions, time constraints and related data structure and command) are further described herein below. Such features provide several technical advantages. For example, the wireless performance of the digital transmitter is improved (e.g., the FEM can extend the dynamic range (DR) of the digital transmitter with minimum impact, if any, to signal linearity), without increasing the chip area size that would have otherwise been needed for a similarly performing analog transmitter. These and other technical advantages are further described herein below.

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

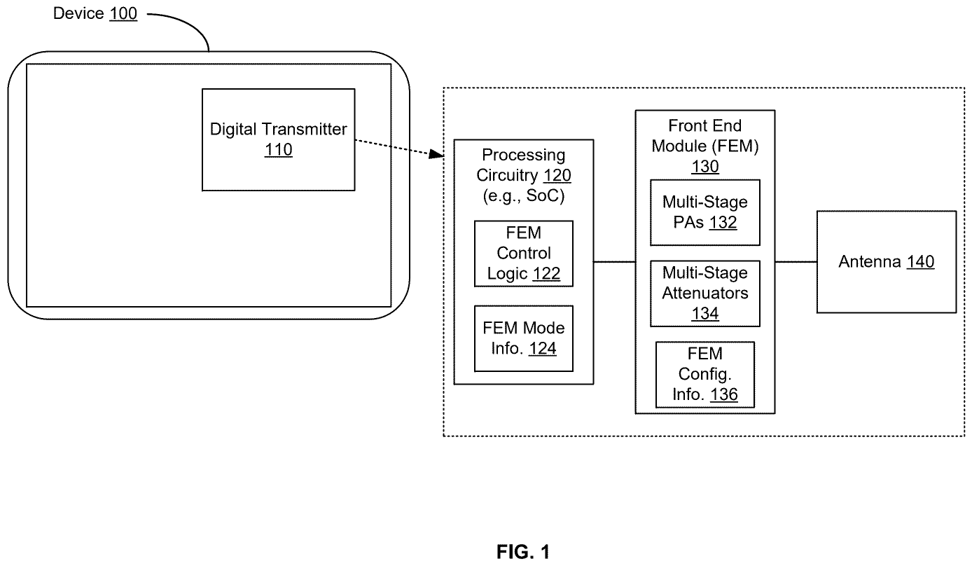

FIG. 1 illustrates an example of a device 100 that includes a digital transmitter 110, in accordance with various embodiments. The digital transmitter 110 can enable the device 110 to transmit signals (e.g., ones encoding information according to a communication protocol, such as WiFi, Bluetooth, cellular, or other protocols). To do so, the digital transmitter 110 can include, among other components, a processing circuitry 120, a FEM 130, and antenna 140. The FEM 130 is coupled with the processing circuitry 120 and the antenna 140, whereby a signal that is output by the processing circuitry 120 is amplified by the FEM 130, and the amplified signal is transmitted by the antenna 140.

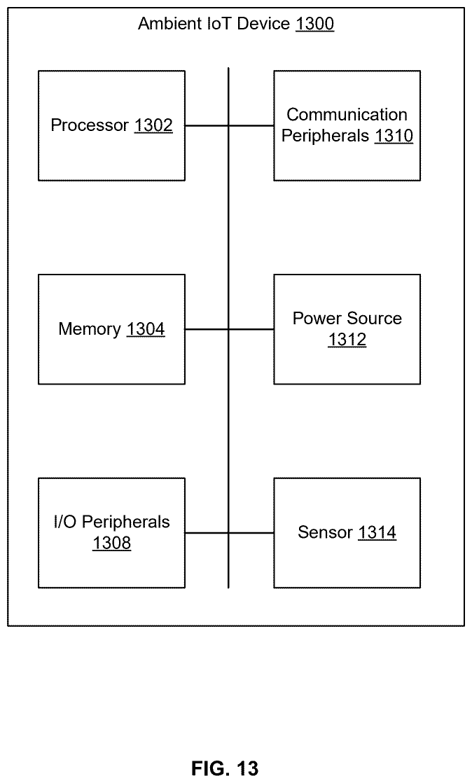

In an example, the device 100 can be an Internet of Things (IoT) device, a tablet, a smart phone, a laptop, a sensor, an appliance, or any other type of devices that supports communications (at least transmission) with other devices. In additional to the digital transmitter 110, the device can include other components such as one or more processors and one or more memories storing instructions executable by the one or more processors to provide different functionalities and, at least partially, control operations of the digital transmitter 110. Examples of such components are further illustrated in FIG. 13.

The processing circuitry 120 can process a signal (e.g., a baseband signal) for transmission. The signal can be output by the processing circuitry at a first output power within a first dynamic range (DR) of the processing circuitry 120. In an example, the processing circuitry 120 can include an SoC having different processors and memories. The processing circuitry 120 can store FEM control logic 122 (e.g., as a set of instructions in the memories, where these instructions are executable by the processors). The processing circuitry 120 can also store FEM mode information 124 (e.g., as information that can used in the execution of the FEM control logic 12 to select a FEM mode). The FEM control logic 122 can select a FEM mode from a plurality of FEM modes to use as part of the signal transmission (e.g., for use in the amplification of the signal corresponding to a packet or frame processed by the processing circuitry and to be output from the digital transmitter 110). A FEM mode can be referred to as a transmission mode and can include one or a combination of a PA mode or an attenuator mode, which are further described herein below. The FEM mode selection can depend on a number of transmission parameters, such as a target output power (e.g., the power to be used at the output of the FEM for the signal transmission), the output power of the processing circuitry 120 (e.g., the power at which the processing circuitry 120 outputs the signal), the MCS rate used in the modulation by the processing circuitry 120, the temperature (e.g., the ambient temperature of the environment in which the device 100 is located or the operational temperature of components of the device 100 such as that of the processing circuitry 120 and/or the FEM 130). The FEM mode information 124 can represent a data structure (e.g., a table) that associates values of these transmission parameters with the FEM modes such that to enable the selection of the relevant FEM mode given specific transmission parameter values.

The FEM 130 FEM can represent an interface between the processing circuitry 120 and the antenna 140. In the receive path, one of the FEM functions includes to improve the system level sensitivity by using external low noise amplifier (eLNA). Usually, insertion loss can exist between the processing circuitry 120 and the antenna 14, which degrades the receive performance. The eLNA can compensate the insertion loss. In the transmit path, one of the FEM functions includes providing output RF power output by an external PA (ePA) to extend the range. Usually, the implementing high power amplifiers at the processing circuitry 120 is challenging. Additionally due to loss between the processing circuitry 120 and the antenna 140, the power amplification is expected to be close to the antenna 140. The FEM 130 can include several components, such as eLNA, ePA (as further described herein), low dropout (LDO) regulators, switches, digital sections, and several mixed signal circuitries for power detection, temperature sensors, and the like. Additionally, the FEM 130 can include an RF front end (RFFE) interface, besides a general purpose input/output (GPIO) and other interfaces with the processing circuitry 120. The FEM 130 can support several modes of operation in transmit and receive paths (including FEM modes further described herein) to improve performance and efficiency in various transmission conditions. The FEM 130 can interface with several wireless technology sub systems (which the processing circuitry 120 can include) including WiFi, Bluetooth, ultra-wide band, and even cellular SoCs.

In an example, the FEM 130 includes multi-stage PAs 132 and multi-stages attenuators 134 and stores (e.g., in a memory) FEM configuration information 136. The multi-stage PAs 132 can represent an ePA that enables controllably switching ON and OFF different PA stages and/or adjusting the gain of one or more PAs. The multi-stages attenuators 134 can represent an external attenuator that is coupled with an input of the ePA and that can be controllably switched. The controllable switching of the ePA and/or external attenuator can be according to the FEM configuration information 136 to achieve a target output power of the FEM 130 for the signal transmission. for instance, the FEM configuration information 136 can indicate the stages to be switched ON and/or OFF and the PA gains to use for a particular FEM mode. The FEM mode can be indicated to the FEM 130 in a command from the processing circuitry 120.

The antenna 140 can be any type of antenna (including possible an antenna array that supports beamforming and/or MIMO communications). Generally, the input of the antenna 140 is coupled with the output of the FEM 130.

In an example, wireless local area network (WLAN) and cellular SoC designs tend to use maximum integration at advanced scaled CM OS technologies. A conventional analog transmitter uses mixers, filters, digital to analog converters, and PAs to deliver wider RF power dynamic range but at a much bigger size than a digital transmitter. Digital transmission (DTx) and digital power amplification (DPA) have emerged as a solution to address the need for a compact and efficient transmitter that can operate at low voltages, sub-nanometer technologies with high-speed switches. Several architectures exist for DTX and DPA in polar and quadrature transmitters, including radio frequency DAC (RFDAC) and switch capacitor topologies. RFDAC architecture using current steering is commonly adopted for wireless radio design with high channel bandwidth requirements. Nonetheless, an RFDAC-based DTX can have a limited effective number of bits (ENOB) which can limit the dynamic range (DR) the transmitter can deliver. Any extra DR can come at the cost of extra bits at the RFDAC which highly affect the size, power consumption and the performance. The limited DR of the DPA can be hard to address at the SoC due to linearity limitations. This issue can be better addressed by implementing a solution outside of the SoC. As illustrated in FIG. 1 and this disclosure, the disclosed solution is implemented at the FEM 130.

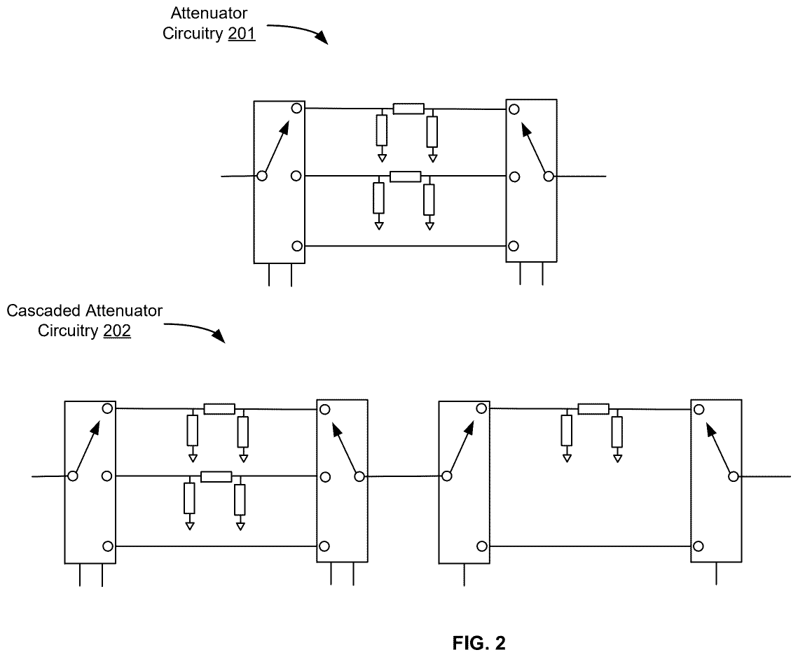

FIG. 2 illustrates an example of attenuator circuitries that can be used in a digital transmitter, in accordance with various embodiments. Such circuitries can include using programmable attenuators or switched attenuators implemented outside of the SoC as an alternative to the FEM level solution.

The top part of FIG. 2 shows an attenuator circuitry 201. This circuitry 201 includes a set of switches and a set of attenuators (shown as Pi attenuators on different lines between the set of switches, where each of the attenuator can provide a particular amount (e.g., 5 dB, 10 dB, 12 dB, etc.) of gain attenuation. The specific values in this paragraph and other paragraphs of the disclosure are provided for illustrative purposes only. Other values are likewise possible. The left switch of the attenuator circuitry 201 in FIG. 2 can be coupled with an SoC (or, more generally, processing circuitry) by having its input connected to an output of the SoC. The right switch of the attenuator circuitry 201 in FIG. 2 can be coupled with a FEM by having its output connected to an input of the FEM. A GPIO bank or some other interface (e.g., an RFFE interface) can control each of the switches such that a particular attenuator (or no attenuator at all) is switched ON. The FEM can be set to provide a maximum gain and the switched ON attenuator can attenuate that gain to achieve a target power at the output of the FEM.

The bottom part of FIG. 2 shows a cascaded attenuator circuitry 202. This circuitry 202 includes multiple attenuator circuitries (each the same or similar to the attenuator circuitry 201) coupled with each other in a cascaded manner (e.g., in series).

Either circuitry 201 or 202 can be implemented as a component between the SoC and the FEM, on a main logic board (MLB) or a transmit/receive (TR) switch. Generally, the FEM is designed to be high PA gain to provide sufficient margin to cover the needed minimum gain in order to compensate for gain variation due to different factors and additional insertion loss between the SoC and antenna, which can vary significantly between platforms. These additional margins add extra burden to the attenuator design. As a result, the transmitter performance can be limited.

In comparison, and as further described in connection with the next figures, the dynamic range issue can be addressed at the FEM level by combining PA modes with lower intrinsic gain optimized for different MCSs (e.g., different quadrature amplitude modulation (QAM) rates or other MCS rates), in addition to using programmed attenuators. This approach can optimize the transmitter performance while moving the ePA to its optimum region of operation, particularly for higher MCS rates.

Generally, the FEM level solution involves an ePA with several FEM modes of operations based on ePA stages (e.g., of which can be a number of ePA segments), where these modes can be optimized for different MCS rates and target powers at the FEM's output. The solution can also include a configuration with a programmable external attenuator that offers adjustable steps. Power range segments can be defined to control the ePA and/or external attenuator, taking into account SoC performance, MCS rate, and ePA gain variation with temperature. The SoC can also be at an optimum back off power. Gain steps withing power segments can be optimized depending on a number of transmission parameters including, for instance, the MCS (e.g., the QAM rate). Because the gain can vary with the temperature, the control of the ePA and/or external attenuator can account for the temperature (ambient and/or operational). An interface can be implemented to program the ePA modes and external attenuator with flexible combinations at minimum RFFE write commands using, for example, a Reg0 that is partitioned. Such use of command can support time constraints for controlling the ePA gain and/or external attenuator per packet transmission. These and other features are further described in connection with the next figures.

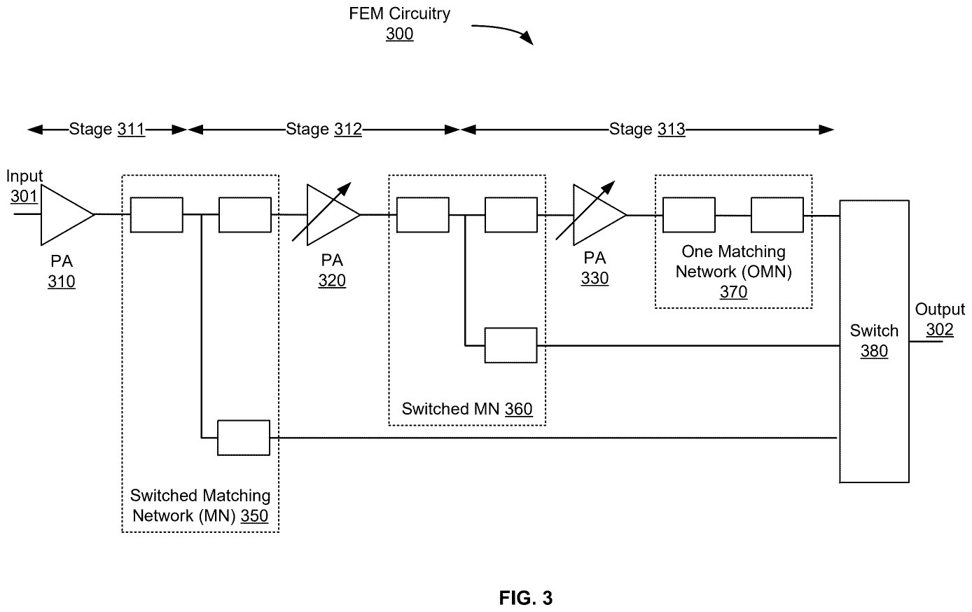

FIG. 3 illustrates an example of a FEM circuitry 300 of a digital transmitter, where the FEM includes a plurality of PA stages, in accordance with various embodiments. Although the FEM circuitry 300 can include other components (e.g., eLNA, LDO regulator, etc.), FIG. 3 shows the PA stages only to illustrate an example of an ePA. Furthermore, although three PA stages are shown, the FEM circuitry 300 is not limited as such and can include two or more PA stages (for example, two PA stages, four PA stages, or any other number). The FEM circuitry 300 can be implemented as a component of a FEM (e.g., the FEM 130 of FIG. 1). Generally, an input side of the FEM can be connected to an SoC (or any other type of processing circuitry). An output side of the FEM can be connected to an antenna. The input drive power of the FEM can be a function of the output power Pₒᵤₜ of the SoC (or the applicable processing circuitry). Whereas this output power Pₒᵤₜ is within a first dynamic range, the output power Pₒᵤₜ of the FEM can be within an expanded second power range and can depend on the use of one or more of the PA stages for gain (and as described in the next figure attenuation stages for attenuation).

As illustrated, a first stage 311 of the FEM circuitry 300 includes a PA 310 and a switched matching network (MN) 350. The PA 310 is not illustrated as having but may have an adjustable gain. The switched MN 350 can include switching elements (e.g., transistors or diodes) to rapidly select between different matching sub-networks, allowing for fast and dynamic impedance matching. The input of the first stage 311 can correspond to an input 301 of the FEM and be connected to an output of an SoC (e.g., the processing circuitry 120 of FIG. 1). A first output of the first stage 311 can be connected to an input of a second stage 312 of the FEM circuitry 300, whereas a second output of the first stage 311 can be connected to a switch 380, thereby enabling the first stage 311 to be switched ON while the second stage 312 is also switched ON or OFF.

The second stage 312 includes a PA 320 and a switched MN 360. The PA 320 is illustrated as having but may not have an adjustable gain. The input of the second stage 312 can be connected to an output of the first stage 311. A first output of the second stage 312 can be connected to an input of a third stage 313 of the FEM circuitry 300, whereas a second output of the second stage 312 can be connected to the switch 380, thereby enabling the second stage 312 to be switched ON while each one of the first stage 311 and the third stage 313 is also switched ON or OFF.

The third stage 313 includes a PA 330 and a one matching network (ON) 370 (e.g., a resonant matching network that does not include switches). The PA 330 is illustrated as having but may not have an adjustable gain. The input of the third stage 313 can be connected to an output of the second stage 312. An output of the third stage 313 can be connected to the switch 380, thereby enabling the third stage 313 to be switched ON while each one of the first stage 311 and the second stage 312 is also switched ON or OFF.

The switch 380 can be connected to the three stages 311-313 at its input side, whereas its output can be connected to an output 302 of the FEM. The switch 380 can be controlled (e.g., via a GPIO bank or an RFFE interface) to switch ON and OFF any, a combination, or all of the stages 311-313. The control can be via a command of a processor (or, more specifically, a controller) of the FEM. Particularly, upon receiving a command of the SoC indicating a FEM mode to use, the FEM's processor can determine from a data structure (e.g., the FEM configuration information 136) the configuration corresponding to the FEM mode, and can control the switch 380 accordingly (in addition to controllably adjusting PA gain(s) as applicable). Programmable bias and matching can be used to adjust the gain of each stage while maintaining the linearity performance.

The stages 311-313 (or, more specifically their PAs 310, 320, 330) may, but need not, be implemented using the same semiconductor materials. For instance, one PA may use gallium arsenide (GaAs), while other PAs may use silicon on insulator (SOI), silicon germanium (SiGe), or complementary metal oxide semiconductor (CM OS). In other words, a hybrid topology using different materials is possible.

Different FEM modes are possible to define. H ere, because the FEM circuitry does not include an external attenuator, the FEM modes correspond to power modes (also referred to as ePA modes or PA modes). Each FEM mode enables a certain range of gains within a dynamic range of the FEM, can be optimized for a particular set of transmission parameters, and corresponds to a different configuration of the stages PA 311-313. Any number of FEM modes can be possible and there need not be a one-to-one correspondence between the number of FEM modes and the PA stages or the possible configurations of the PA stages. The transmission parameters can include any or a combination of target output power of the FEM, output power of the SoC (or, similarly, the input power to the FEM), the MCS (e.g., the particular QAM rate used by the SoC for modulating a signal corresponding to a packet transmission), the temperature, and/or the back off power of the SoC. The configuration corresponding to an FEM mode can include a particular switching of the stages 311-313 (e.g., stage 311 being switched ON, while stages 312-313 being switched OFF, or stages 311 and 312 being switched ON, while stage 312 being switched OFF). Additionally, or alternatively, this configuration can include a particular adjusted gain of a PA (e.g., the gain of PA 320 of the second stage 312 can be controllably adjusted to a particular target value).

In an example, the ePA is configured to have access to all stages 311-313 to enable each at different back off power. In the illustration of FIG. 3, the ePA can be a three-stage WLAN ePA for 5-7 GHz. Each stage can be segmented and have a programmable bias and matching to adjust the gain while maintaining the linearity performance. Several transmit states are defined based on above topology, considering the target power, MCS rate, and other transmission parameters in order to define modes with lower intrinsic gain as the target power decreases. Several FEM transmit states can be defined, including high-power (HP), mid-power (MP), low-power (LP), and bypass (BP). In each PA drive's periphery, the bias can be adjusted to meet the performance requirements while simultaneously adjusting the output power at saturation (Psat) and gain. Several sub-states can be defined at each state as needed like MP1, MP2, etc. To cover the whole dynamic range, PA modes with lower intrinsic gains can be enabled as the target power shifts further away from maximum output power.

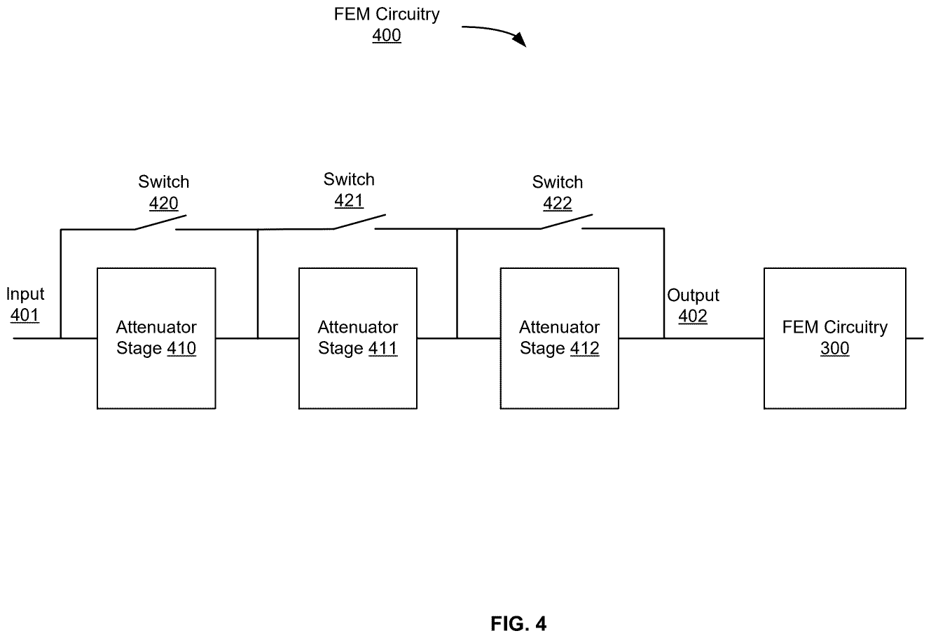

FIG. 4 illustrates an example of a FEM circuitry 400 of a digital transmitter, where the FEM includes a plurality of attenuator stages, in accordance with various embodiments. The FEM circuitry 400 includes the FEM circuitry 300 of FIG. 3 and other components (e.g., eLNA, LIDO regulator, etc.) in addition to the attenuator stages. Three attenuator stages are shown for the sake of illustration, although a different number of attenuator stages are possible, including at least one attenuator stage that can be switched ON and OFF (where this attenuator stage would be bypassed when switched OFF). The number of attenuator stages can be independent of the number of PA stages of the FEM circuitry 300.

An input 401 of the attenuator stages can be connected to an output of an SoC (or, more generally, a processing circuitry). An output of the attenuator stages can be connected to an input of the FEM circuitry. When all the attenuator stages are switched OFF, the attenuator stages can be bypassed, whereby the output of the SoC can be connected to the input of the FEM circuitry 300.

As illustrated, a first attenuator stage 410 can be connected to the input 401. Its output can be connected to an input of the next attenuator stage 411. Similarly, the output of the next attenuator stage 411 can be connected to an input of the last attenuator stage 412 that, in turn, is connected to the output 402. Each of the three attenuator stages can implement a particular attenuator design (e.g., a Pi attenuator) that provides a particular gain attenuation. The gain attenuations can be different across the attenuator stages 410-411.

Each one of the attenuator stages 410-411 can be switched ON or switched OFF (e.g. bypassed) by using a corresponding switch. In the illustration of FIG. 4, the input and output of the attenuator stage 410 are connected to a first switch 420. When the switch 410 is open, the attenuator stage 410 is switched ON. When the switch 410 is closed, the attenuator stage 420 is switched OFF. Similarly, the input and output of the attenuator stage 411 are connected to a second switch 421, and the input and output of the attenuator stage 412 are connected to a third switch 422.

Different attenuation configurations can be defined, each corresponding to particular ON/OFF states of the switches 420-422 (or switching of the attenuator switches 410-412). A configuration can use none, one, a combination of, or all of the attenuator stages 410 and can have a corresponding gain attenuation (this attenuation may be zero or negligent when all the attenuation stages 410-412 are bypassed and maximum when all of these stages 410-412 are switched ON).

In the illustration of FIG. 4, a FEM mode correspond to a combination of a PA mode (as in FIG. 3) and an attenuation mode. Each attenuation mode corresponds to a configuration of the attenuation stages 410-412 and provides a particular gain attenuation. Similarly to the PA modes of FIG. 3, the attenuation modes can be defined for use given a set of transmission parameters, such as target output power of the FEM, output power of the SoC, MCS, temperature, back-off power of the SoC, and the like.

Upon receiving a command of the SoC indicating a FEM mode to use, the FEM's processor can determine from a data structure (e.g., the FEM configuration information 136) the configuration corresponding to the FEM mode. This configuration can include the configuration of the attenuator stages 410-412 (or, equivalently, the states of the switches 420-422), in addition to the configuration of the PA stages. The FEM can control the switches 420-422 accordingly (in addition to controllably the switch 380 and adjusting the PA gains).

Relative to the FEM circuitry 300, the dynamic range can be further extended by adding the attenuator stages 410-412 at the PA input. The attenuator stages 410-412 can have fine and course steps, as needed and made in linear or non-linear (e.g., binary) steps. The attenuators can also be switchable to generate multiple segments. The combination of FEM states and attenuator settings is used to further extend the DR range. This allows for programmable or unequal steps as needed. The ePA and the external attenuator can have independent number of stages.

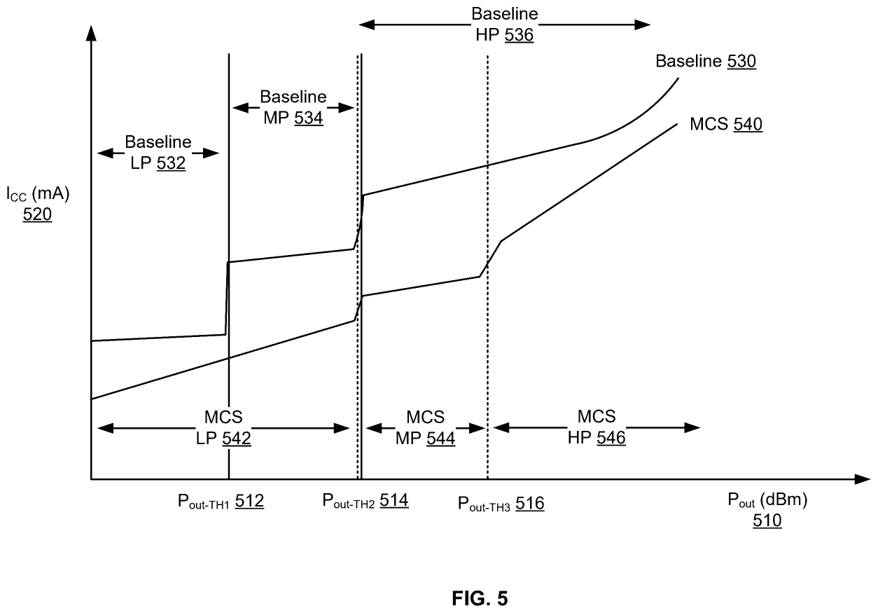

FIG. 5 illustrates an example of a plot of current 520 as a function of power 510, where the plot is usable to define different transmission modes of a FEM, in accordance with various embodiments, in accordance with various embodiments. The current 520 can be electrical current used in power amplification in the FEM. The power 510 can be output power of the FEM. A baseline curve 530 and an MCS curve 540 are shown.

These curves can be derived from current and power measurements of the FEM in a laboratory setup. The baseline curve 530 can correspond to amplification of a signal by the FEM, where the signal corresponds to a baseline modulation (e.g., 1K QAM). The MCS curve 540 can correspond to amplification of a signal by the same FEM, where this signal corresponds to a different modulation (e.g., in the illustrated figure, the MCS has a lower MCS rate than the baseline modulation).

As shown by the two curves 530 and 540, the MCS impacts the performance of the FEM (e.g., current consumption and/or output power). As such, power segments can be defined dependently on the MCS. Such definitions are shown for both the baseline modulation (with solid vertical lines) and the other MCS modulation (with dashed vertical lines).

Starting with the baseline modulation, two power thresholds can be defined P_{out-TH1} 512 and P_{out-TH2} 514 corresponding to a change to the current consumption by a certain amount(s). To the left of P_{out-TH1} 512, a first PA mode can be defined, shown as baseline low-power (LP) 532. Between the two power thresholds P_{out-TH1} 512 and P_{out-TH2} 514, a second PA mode can be defined, shown as baseline mid-power (LP) 534. To the right of P_{out-TH2} 514, a third PA mode can be defined, shown as baseline high-power (HP) 536. As such, three power segments are defined, each corresponding to one of the baseline PA modes.

Turning to the other MCS modulation, two power thresholds can also be P_{out-TH2} 514 and P_{out-TH3} 516 corresponding to a change to the current consumption by a certain amount(s). To the left of P_{out-TH2} 514, a first PA mode can be defined, shown as MCS LP 542. Between the two power thresholds P_{out-TH2} 514 and P_{out-TH3} 516, a second PA mode can be defined, shown as MCS MP 544. To the right of P_{out-TH3} 516, a third PA mode can be defined, shown as MCS HP 546. As such, three power segments are defined, each corresponding to one of the MCS PA modes.

The number and/or width of the power segments need not be the same for the different modulations. Similarly, the number and/or values of the power thresholds need not be the same for the modulations. Generally, current and power measurements can be derived per type of FEM and/or FEM integration with other data transmitter components to derive the different power segments and define the different PA modes per MCS.

Accordingly, PA modes can be defined based on an MCS rate to optimize power amplification performance per MCS rate, improve efficiency at maximum power (e.g., at lower MCS rate) and backed-off power, and/or better utilize the MP and LP modes by switching to them at higher power. A PA mode (e.g., HP) can be optimized for error vector magnitude floor, whereas another PA mode (e.g., also HP) can be optimized for an MCS rate. The switching between the PA modes can happen based on the target output power.

The target power and MCS rate can be combined to extend the PA modes to cover the whole RF dynamic range. For example, information (e.g., in the form of a data structure, such as a table) can be defined based on current and power measurements at the different MCS rates over the entire dynamic range of the FEM. This information can identify the PA mode to use in association with power segments (or power thresholds) and MCS rates. An example of this information is shown in Table 1.

TABLE 1

| | High MCS | | Mid MCS | | Low MCS | |
|---|---|---|---|---|---|---|
| Parameter | Mode | Power Range | Mode | Power Range | Mode | Power Range |
| Tx Mode 1 | HP1 | Pₒᵤₜ > P3 | HP | Pₒᵤₜ > P2 | MP3 | Pₒᵤₜ > P1 |
| Tx Mode 2 | MP1 | P6 < Pₒᵤₜ < P3 | MP2 | P4 < Pₒᵤₜ < P4 | LP1 | P5 < Pₒᵤₜ < P1 |
| Tx Mode 3 | LP | Pₒᵤₜ < P6 | LP1 | Pₒᵤₜ < P4 | LP2 | Pₒᵤₜ < P5 |

In Table 1, high MCS represents an MCS rate that is between two rate thresholds, Mid MCS represents an MCS rate that is smaller than that of High MCS and that is between two rate thresholds, and Low MCS represents an MCS rate that is smaller than that of Mid MCS and that is lower than a rate threshold. Tx Mode 1, Tx Mode 2, and Tx Mode 3 represent three different transmission modes. Pₒᵤₜ represents a target output power of the FEM. HP and HP1 represent two different high power modes (e.g., baseline HP 536 and MCS HP 546), MP1, MP2, and MP3 represent three different mid power modes, and LP1, LP2, and LP represent three different low power modes. Pi, for “i” between “1” and “6” represents power output thresholds.

An SoC can store the information (e.g., Table 1) and perform a look-up based on an MCS rate it used in the signal modulation and based on the target power output to determine the PA mode that the FEM needs to use in the signal amplification. The SoC can indicate the PA mode to the FEM in a command. For instance, assume an MCS rate that meets the definition of the High MCS, and a target output power of 12 dBm. Based on the table look-up, the SoC can determine that the HP2 mode is to be used and can identify this PA mode to the FEM in the command.

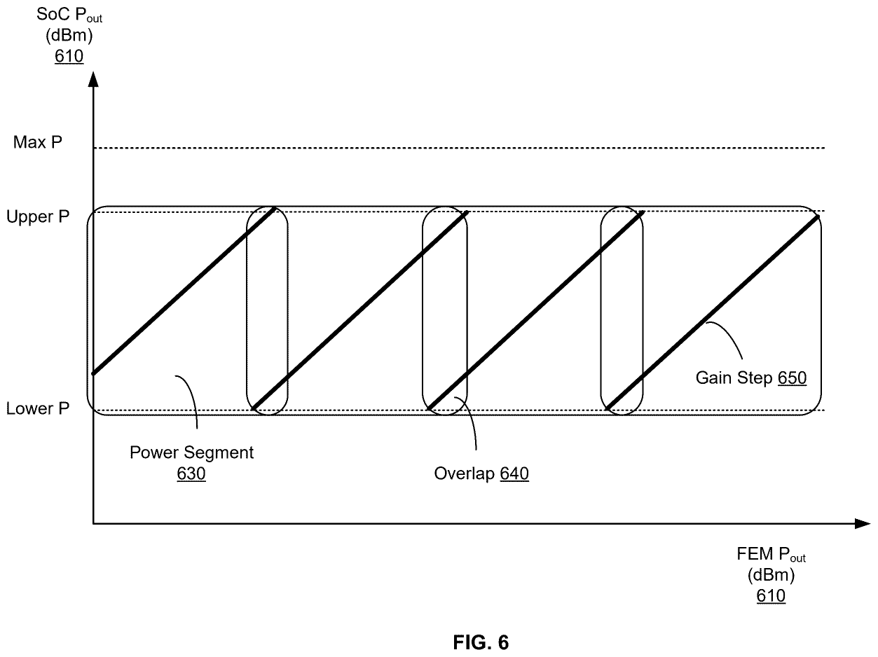

FIG. 6 illustrates an example of power segments and gain steps usable to control a transmission configuration, in accordance with various embodiments. Generally, a FEM's dynamic range can be wider than an SoC's (or, more generally, a processing circuitry's) dynamic range. Power segments (each corresponding to a PA mode) can be defined over the FEM's SoC, where each power segment can cover the entirety of the SoC's dynamic range. Say for example, the SoC's dynamic range is between −10 dBm and −5 dBm and the FEM's dynamic range is between 0 dBm and 15 dBm. Rather than having one power mode for the FEM covering its 0-15 dBm dynamic range, two power segments can be defined: 0-9 dBm and 9-15 dBm. Operating in the first power segment (or PA mode) of 0-9 dBm can cover the entire dynamic range of the SoC (e.g., −10 dBm to −5 dBm). Likewise, operating in the second power segment (or PA mode) of 9-15 dBm can also cover the entire dynamic range of the SoC (e.g., −10 dBm to −5 dBm). Such use of power segments can improve the FEM's power amplification and/or transmission parameters while covering the entirety of the SoC's dynamic range.

Within each power segment, a gain step can be defined, having a start point and end point, where the gain varies across the gain step. The gain step can be used to determine the specific power outputs (and, possibly, power attenuations) to use, as further described herein below.

Referring to the specifics of FIG. 6, the power output Pₒᵤₜ 610 of the SoC is shown on the vertical axis, while the Pₒᵤₜ 620 of the FEM is shown on the horizontal axis. The dynamic range of the SoC is between a lower power (shown as a Lower P), and a maximum Power (show as max P). The SoC can also have a back-off power defining an upper power (shown as Upper P), where the back-off power is the difference between the maximum power and the upper power.

In the illustration of FIG. 6, the dynamic range of the FEM is divided into four power segments (each is generally labeled as power segment 630 and shown with a rounded-edge rectangle). Each power segment 630 covers the SOC's dynamic range (or, possibly, the range between the lower power and the upper power such that the back-off power is accounted for) and can possibly be derived based on current and power measurements as described herein above. The power segments can overlap (an overlap 640 is shown between the second and the third power segments). Within each power segment, a gain step 650 is defined (shown in the figure as a linear function, but other types of functions are possible). The gain step 650 starts at a point corresponding to an initial FEM output power within the power segment and ends at a point corresponding to a higher FEM output power within the power segment.

Generally, the number of power segments need not be limited to four. Furthermore, the sizes of the power segments can vary (e.g., non-uniform power segments can be defined). The overlaps can likewise vary. Additionally, or alternatively, the gain steps can also be different.

Say that the SoC determines a target output of the FEM. Based on this target output power, the SoC can determine the power segment (or, equivalently, the PA mode) for the operation of the FEM and can send a corresponding command to the FEM (which causes it to configure its ePA and, possibly, its external attenuator). The power segment can be the one within which the target output power falls. Given the gain step of the power segment and the target output power (e.g., the intersection point between a vertical line extending from the target output power and the gain step), the SoC can determine a target output power of the SoC (e.g., corresponding to the point on the vertical axis having a horizontal line that extends through the intersection point). The SoC can then configure its power amplifier circuitry to achieve that target power output. Further, the intersection point can correspond to an attenuation from the gain of the power segment (e.g., the maximum gai of the PA mode). This attenuation can be indicated in the command to the FEM such that the FEM can adjust the gain(s) of its ePA and/or switch ON the appropriate attenuation stage(s).

To illustrate, say that the last power segment covers the range of 15 dBm and 20 dBm and corresponds to an LP mode. Say that the target output power of the FEM is 17 dBm. In this case, the SoC determines that the LP mode applies and instructs the FEM accordingly. Say that the intersection point of the 17 dBm vertical line and the gain step of the last power segments results in a target SoC output power of −8 dBm, then the SoC can control its amplification circuitry to achieve the −8 dBm target.

As explained herein above, the power range at the antenna can be significantly wider than what the SoC can provide. To cover the entire range of needed dynamic range, this range can be divided into some sub-segments with overlapping coverage.

The SOC dynamic range varies depending on the modulation rate, which introduces an additional layer of complexity. In the example of RFDAC-based DTX, such transmitter typically provides lower dynamic range for higher MCS rates compared to lower MCS rates. The power segments and/or gain steps can be defined given the MCS rates.

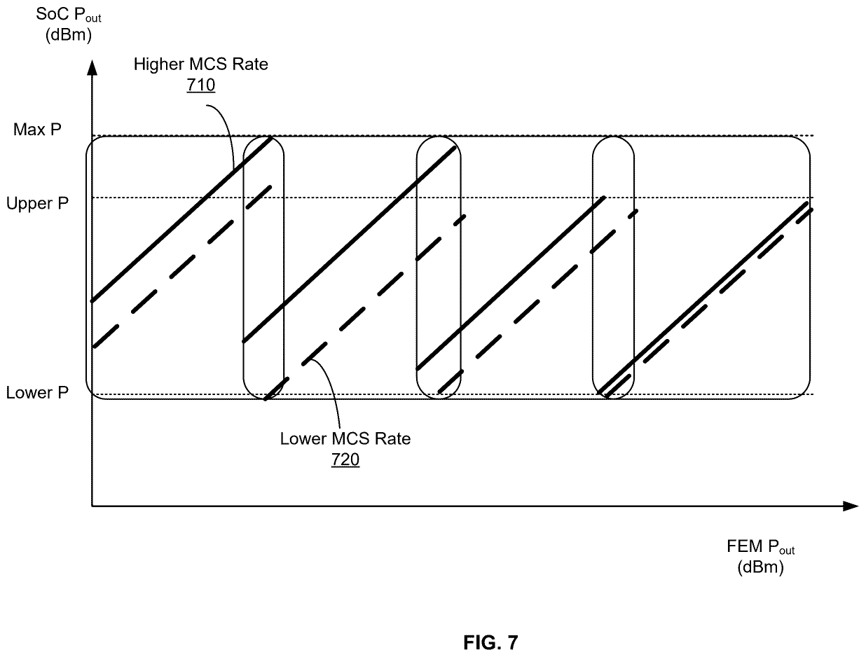

FIG. 7 illustrates another example of power segments and gain steps usable to control a transmission configuration, in accordance with various embodiments. The example is similar to that of FIG. 6. In the interest of brevity, the similarities are not repeated herein and equivalently apply to the example of FIG. 7. Similarly to the example of FIG. 6, the power output Pₒᵤₜ of an SOC is shown on the vertical axis, while the power output Pₒᵤₜ of a FEM is shown on the horizontal axis. The dynamic range of the SoC is between a lower power, and a maximum Power. The SoC can also have a back-off power defining an upper power. Four power segments and overlaps between them are shown. Within each power segment, a gain step is defined. The gain steps are shown for two different modulations: gain steps for relatively higher MCS rate 710 (e.g. 1K QAM) are shown with solid lines, whereas gain steps for relatively lower MCS rate 720 (e.g. 64 QAM) are shown with dashed lines.

The gain steps of the two MCS rates 710 and 720 can be different. For example, and relative to the lower MCS rate 720, the higher MCS rate's 710 gain step in the first the power segment (to the left of FIG. 7) starts at an SoC output power larger than that that of the lower MCS rate 720 and ends at the maximum SoC power. In comparison, the gain steps of the two MCS rates 710 and 720 in the last power segment (to the right of FIG. 7) are closer to each other. The various power segments and gain steps can be defined based on measurements performed per MCS rate, as described herein above.

Accordingly, the gain steps in the FEM can be adjusted to ensure optimal performance at each MCS rate, while also supporting the design where the SoC delivers different DR at different MCS rates. The gain steps can be adjusted to allow the SoC's PA to operate at much higher power for lower MCS rates as the ePA output power decreases. Different gain steps may be needed for different MCS rates.

Furthermore, the gain steps in the FEM can be adjusted to ensure that the SOC operates within its optimal range. Initially, at high ePA target output power, the SOC can operate in the back-off region, which is more linear. As the ePA target output power decreases, the FEM states and attenuator can be adjusted to shift the SOC's PA to a higher power level, thereby maintaining the required SN R. The drive level and gain steps are adjusted to position the SOC in the optimal region.

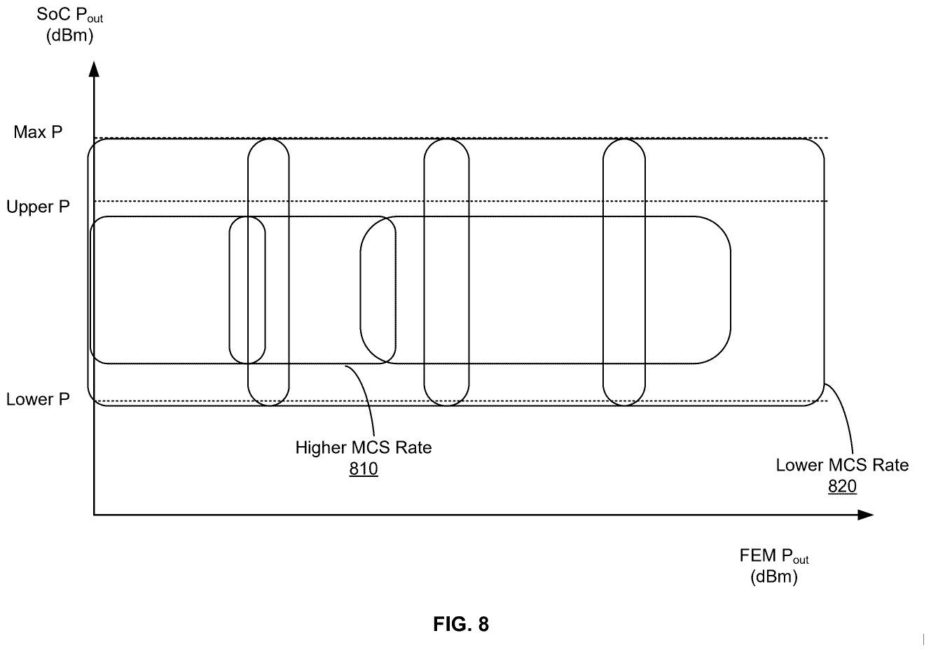

FIG. 8 illustrates another example of power segments and gain steps based on MCSs, in accordance with various embodiments. The example is similar to that of FIG. 6. In the interest of brevity, the similarities are not repeated herein and equivalently apply to the example of FIG. 8. Similarly to the example of FIG. 6, the power output Pₒᵤₜ of an SOC is shown on the vertical axis, while the power output Pₒᵤₜ of a FEM is shown on the horizontal axis. The dynamic range of the SoC is between a lower power, and a maximum Power. The SoC can also have a back-off power defining an upper power.

As illustrated in FIG. 8, the definition of the power segments can depend on the MCS rate. Relative to a higher MCS rate 810, the power segments of a lower MCS rate 820 can cover a larger dynamic range of the SoC and/or a larger dynamic range of the FEM. Furthermore, the number of power segments can also vary depending on the MCS rate (e.g., showing four power segments for the lower M C rate 820 and three segments for the higher MCS rate 810 in FIG. 8). Although not shown in FIG. 8, the gain steps can also vary between the MCS rates. The various power segments can be defined based on measurements performed per MCS rate, as described herein above.

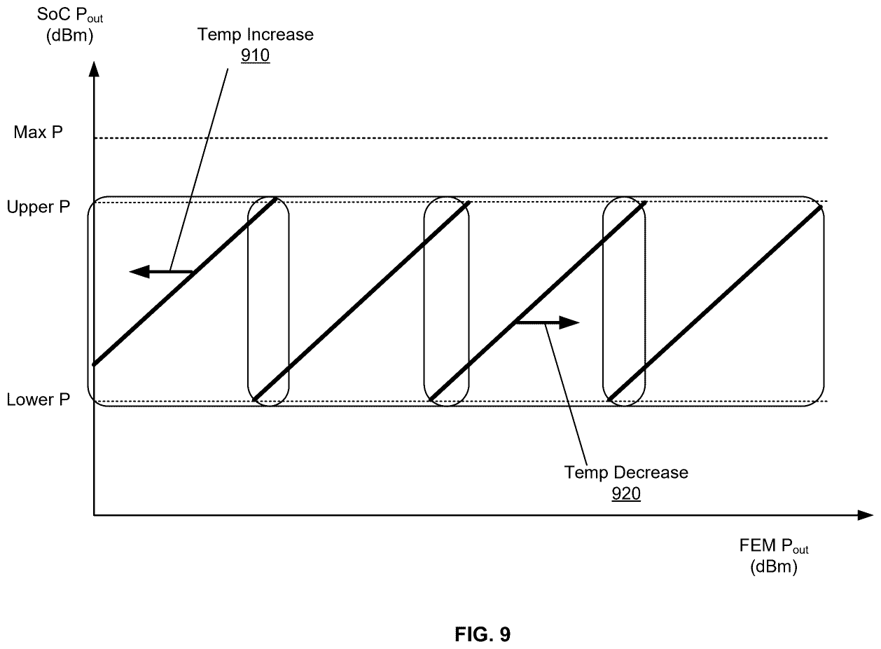

FIG. 9 illustrates another example of power segments and gain steps based on temperature, in accordance with various embodiments. The example is similar to that of FIG. 6. In the interest of brevity, the similarities are not repeated herein and equivalently apply to the example of FIG. 9. Similarly to the example of FIG. 6, the power output Pₒᵤₜ of an SOC is shown on the vertical axis, while the power output Pₒᵤₜ of a FEM is shown on the horizontal axis. The dynamic range of the SoC is between a lower power, and a maximum Power. The SoC can also have a back-off power defining an upper power. Four power segments and overlaps between them are shown. Within each power segment, a gain step is defined.

The FEM's gain can vary depending on a number of parameters such as frequency and temperature. This variation can be accounted for in the definition of the power segments and/or gain steps. In FIG. 9, the definition of the gain steps depends on the temperature (ambient or operational temperature). Similar definitions can be derived for gain step variations over frequencies and/or power segments variations over frequencies and/or temperatures through measurements, as described herein above, corresponding to the different frequencies and/or temperatures.

As illustrated in FIG. 9, the gain steps can be defined for a baseline temperature (or a baseline temperature range). For a hotter condition (e.g., a temperature increase 910 larger than the baseline temperature by a certain temperature threshold or that is outside the baseline temperature range and within a hotter temperature range), the gain steps can be adjusted in one or more ways. The adjustment in FIG. 9 is shown as a horizontal shift to the left of the gain steps by a certain dBm amount derived from the measurements. This shift corresponds to a decrease to the gain of the FEM's PA. Conversely, for a colder condition (e.g., a temperature decrease 920 smaller than the baseline temperature by a certain temperature threshold or that is outside the baseline temperature range and within a colder temperature range), the gain steps can be adjusted in one or more ways. The adjustment in FIG. 9 is shown as a horizontal shift to the right of the gain steps by a certain dBm amount derived from the measurements. This shift corresponds to an increase to the gain of the FEM's PA.

In one example, the SoC stores information (e.g., in a data structure) that defines the baseline gain steps and the shift per temperature change (or temperature change range). In another example, the SoC stores information (e.g., in a data structure) that defines not only the baseline gain steps, but the gain steps per each temperature (or temperature range). A closed loop position control (CLPC) of the SoC can adjust both the gain steps and SOC drive to meet the target power at each segment, as the ePA gain varies with temperature.

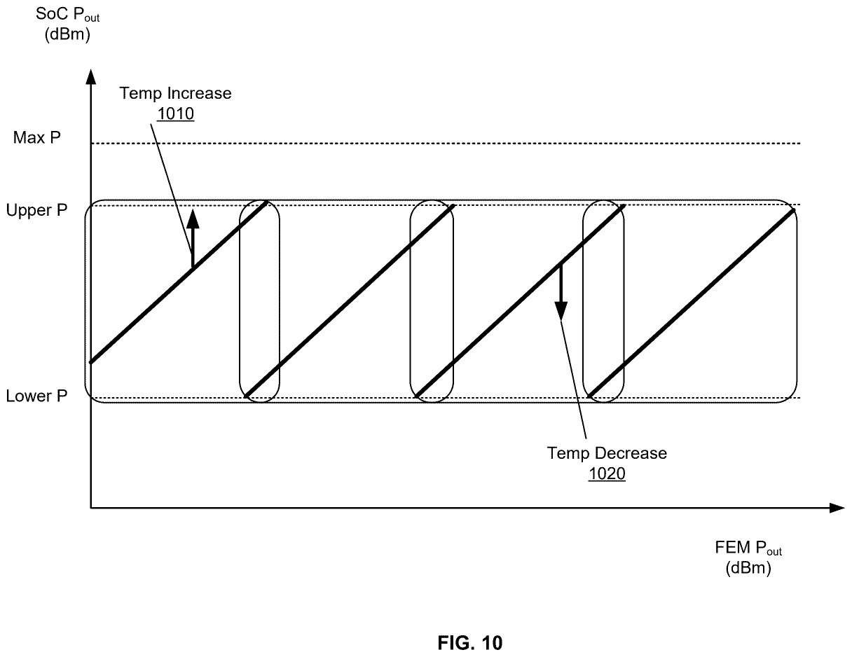

FIG. 10 illustrates yet another example of power segments and gain steps based on temperature, in accordance with various embodiments. The example is similar to that of FIG. 6. In the interest of brevity, the similarities are not repeated herein and equivalently apply to the example of FIG. 10. Similarly to the example of FIG. 6, the power output Pₒᵤₜ of an SOC is shown on the vertical axis, while the power output Pₒᵤₜ of a FEM is shown on the horizontal axis. The dynamic range of the SoC is between a lower power, and a maximum Power. The SoC can also have a back-off power defining an upper power. Four power segments and overlaps between them are shown. Within each power segment, a gain step is defined.

As explained herein above, the FEM's gain can vary depending on a number of parameters such as frequency and temperature. In FIG. 10, the definition of the gain steps depends on the temperature (ambient or operational temperature). Similar definitions can also be derived for gain step variations over frequencies and/or power segments variations.

As illustrated in FIG. 10, the gain steps can be defined for a baseline temperature (or a baseline temperature range). For a hotter condition (e.g., a temperature increase 1010 larger than the baseline temperature by a certain temperature threshold or that is outside the baseline temperature range and within a hotter temperature range), the gain steps can be adjusted in one or more ways. The adjustment in FIG. 10 is shown as a vertical upward shift of the gain steps by a certain dBm amount derived from the measurements. This shift corresponds to an increase to the gain of the SoC's PA. Conversely, for a colder condition (e.g., a temperature decrease 1020 smaller than the baseline temperature by a certain temperature threshold or that is outside the baseline temperature range and within a colder temperature range), the gain steps can be adjusted in one or more ways. The adjustment in FIG. 10 is shown as a vertical downward shift of the gain steps by a certain dBm amount derived from the measurements. This shift corresponds to a decrease to the gain of the SoC's PA.

Accordingly, the SOC dynamic range can be partitioned to reserve a guard band to adjust the SOC's PA power as the FEM gain varies with temperature. Consequently, the CLPC can only adjust the SOC drive level to meet the target power while the ePA gain varies. The number of power segments (or PA modes) can increase if the ePA gain variation is wide or if the SoC dynamic range is limited.

As described in FIGS. 5-10, an SoC can store information (e.g., a data structure) defining power segments and gain steps in association with different transmission parameters including target output power of a FEM, target power of the SoC, MCS rate, temperature, frequency, etc. A power segment can correspond to a FEM mode (including a PA mode and/or an attenuator mode). Points or sections of a gain step within the power segment can correspond to an adjustable gain(s) of a PA within the ePA of the FEM and/or a switchable attenuation stage within the external attenuator of the FEM.

The FEM can store similar information defining the power segments and gain steps (or, similarly, the FEM modes including the PA modes and/or attenuator modes) in association with the PA configuration (e.g., switching of PA stages and/or adjusting PA gains) and/or with attenuator configuration (e.g., switching of attenuator stages).

By using on one or more of the transmission parameters in a lookup of the SoC-stored information, the SoC can determine the appropriate FEM mode to use and send a command to the FEM indicating this FEM mode to use. By using the indication of the FEM mode in a look-up of the FEM-stored information, the FEM can determine the PA and attenuator configurations to use.

In an example, the FEM can store a set of entries, each entry indicating the FEM mode (and possible the FEM configuration of the ePA and the external attenuator). The SoC can send a command including bits that correspond to one of the entries. By looking up the indicated entry, the FEM can then determine the FEM mode and/or the FE configuration. This approach can be used in time-constrained architectures having short inter-frame switching (IFS), such as ones have a couple of microseconds. In particular, a Reg0 of the FEM can store the entries. The command can include a first set of bits (e.g., the first five bits) that indicate a first entry in the Reg0 corresponding to the PA mode and a second set of bits (e.g. the last 2 bits) that indicate a second entry in the Reg0 corresponding to the attenuator mode. As such, a single command can be used to identify both modes and corresponding configurations.

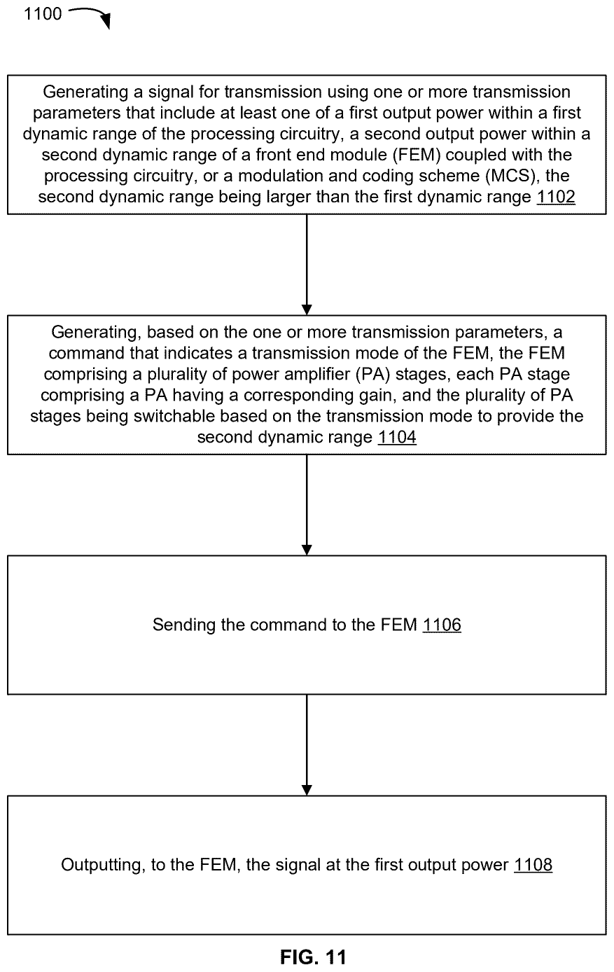

FIG. 11 illustrates an example of an operational flow/algorithmic structure 1100 for controlling a FEM, in accordance with various embodiments. The operational flow/algorithmic structure 1100 can be implemented by an apparatus of a device (e.g., the apparatus includes processing circuitry, such as an SoC, or more generally the processing circuitry 120 of FIG. 1). In some embodiments, the operational flow/algorithmic structure 1100 may be implemented by executing instructions stored in a tangible, non-transitory, computer-readable storage medium, such as a memory of the device. While the operational flow/algorithmic structure 1100 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1100 includes, at 1102, generating a signal for transmission using one or more transmission parameters that include at least one of a first output power within a first dynamic range of the processing circuitry, a second output power within a second dynamic range of a front end module (FEM) coupled with the processing circuitry, or a modulation and coding scheme (MCS), the second dynamic range being larger than the first dynamic range. For instance, the processing circuitry modulates information for transmission as a packet using a signal. The MCS maybe have a particular MCS rate that is known to the processing circuit. The target output power of the FEM may be known to the processing circuit (e.g, based on a priority of the packet or a command from an access point or a base station). The target output power of the processing circuit may also be known to the processing circuit (based on its dynamic range or being derived given a power segment, a gain step, and the FEM's target output power as described in the above figures).

In an example, the operational flow/algorithmic structure 1100 includes, at 1104, generating, based on the one or more transmission parameters, a command that indicates a transmission mode of the FEM, the FEM comprising a plurality of power amplifier (PA) stages, each PA stage comprising a PA having a corresponding gain, and the plurality of PA stages being switchable based on the transmission mode to provide the second dynamic range. An example of the FEM's circuitry is shown in FIGS. 3-4 and can be referred as an ePA (as in FIG. 3) or as an ePA and external attenuator (as in FIG. 4). The processing circuitry can store information (e.g., similar to Table 1) that associates the FEM mode (e.g., also referred to as the transmission mode) with the one or more transmission parameters. Accordingly, this information is looked up using the values of the transmission parameters to identify the FEM mode.

In an example, the operational flow/algorithmic structure 1100 includes, at 1106, sending the command to the FEM. For example, the command can indicate the PA mode and, optionally, the attenuation mode to use. In a further example, the same single command can be directed to Reg0 of the FEM.

In an example, the operational flow/algorithmic structure 1100 includes, at 1108, outputting, to the FEM, the signal at the first output power. Here, after the processing of the signal, the SoC amplifies (e.g., using its own set of amplifiers) and outputs it to the FEM. The timing of the output can be such that the signal is output after a time interval (e.g., a few microseconds) from the sending of the command, where the time interval is sufficient for the FEM to process the command and configures its PAs and attenuators accordingly.

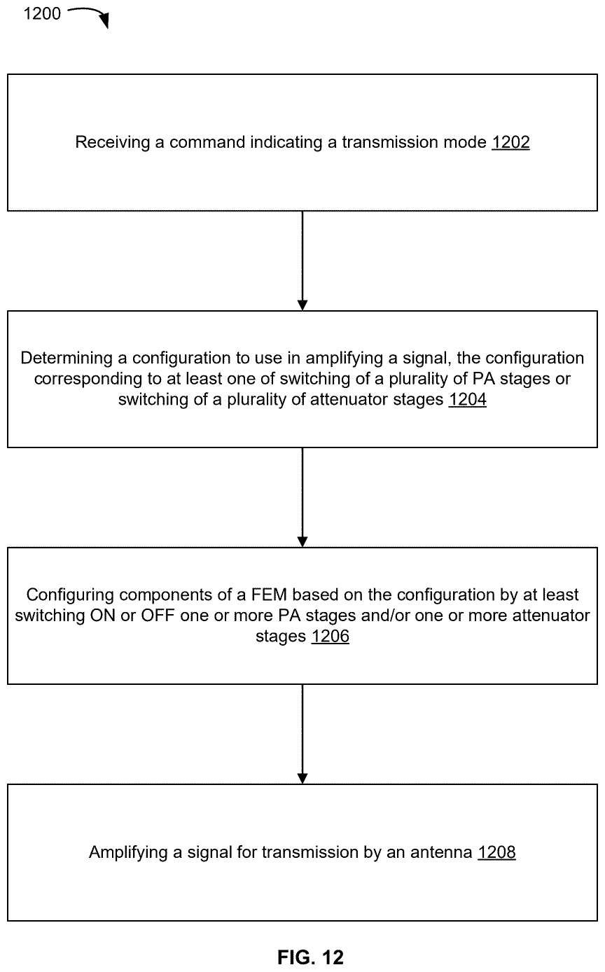

FIG. 12 illustrates an example of an operational flow/algorithmic structure 1200 for configuring components of a FEM, in accordance with various embodiments. The operational flow/algorithmic structure 1200 can be implemented by an apparatus of a device (e.g., the apparatus includes a FEM, such as the FEM 130 of FIG. 1). In some embodiments, the operational flow/algorithmic structure 1200 may be implemented by executing instructions stored in a tangible, non-transitory, computer-readable storage medium, such as a memory of the device. While the operational flow/algorithmic structure 1200 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 1200 includes, at 1202, receiving a command indicating a transmission mode. The command can be the same command described in connection with step 1106 of FIG. 11.

In an example, the operational flow/algorithmic structure 1200 includes, at 1204, determining a configuration to use in amplifying a signal, the configuration corresponding to at least one of switching of a plurality of PA stages or switching of a plurality of attenuator stages. For example, the signal can be received after the command is received according to the time interval described in connection with steps 1108 of FIG. 11. Prior to receiving the signal, the FEM can determine, from the command, the PA mode and/or attenuator mode and can determine the corresponding PA configuration and/or attenuator configuration.

In an example, the operational flow/algorithmic structure 1200 includes, at 1206, configuring components of a FEM based on the configuration by at least switching ON or OFF one or more PA stages and/or one or more attenuator stages. By controlling related switches, the relevant PA stages are switched ON and, as applicable, remaining ones are switched OFF. similarly, the relevant attenuator stages are switched ON and, as applicable, remaining ones are switched OFF.

In an example, the operational flow/algorithmic structure 1200 includes, at 1208, amplifying a signal for transmission by an antenna. H ere, the signal is received after the switching of the PA stages and/or PA attenuators and is amplified (and, possibly attenuated) based on the enabled PA stages (and, possibly, the enabled attenuator stages).

FIG. 13 illustrates a device 1300, in accordance with some embodiments. The device 1300 is an example of the devices described herein above. For example, the device 1300 can implement an ePA at the FEM level.

In an example, the device 1300 includes a power source 1312 that can supply power to other components of the device 1300. The power source 1312 can include a power storage component (e.g., a set of capacitors, a rechargeable battery cell, etc.) and an energy harvesting component (e.g., a solar panel). The other components can include at least a processor 1302, a memory 1304, input/output peripherals (I/O) 1308, communication peripherals 1310, and sensors 1314. An interface bus can be configured to communicate, transmit, and transfer data, controls, and commands among the various components of the device 1300. The memory 1304 can include computer-readable storage media, such as RAM; ROM; electrically erasable programmable read-only memory (EEPROM); hard drives; CD-ROM s; optical storage devices; magnetic storage devices; electronic non-volatile computer storage, for example, Flash® memory; and other tangible storage media. Any of such computer readable storage media can be configured to store instructions or program codes embodying aspects of the disclosure. The memory 1304 can also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the device 1300.

Further, the memory 1304 includes an operating system, programs, and applications. The processor 1302 is configured to execute the stored instructions and includes, for example, a logical processing unit, a microprocessor, a digital signal processor, and other processors. The I/O peripherals 1308 can include user interfaces, such as a light source; an alarm device; a keyboard; screen (e.g., a touch screen); microphone; speaker; other input/output devices; and computing components, such as graphical processing units; serial ports; parallel ports; universal serial buses; and other input/output peripherals. The sensors 1314 can be configured to detect events or changes in their environment and send the information (sensor data) about the detected events to some other device, module, or system. Examples of such sensors 1314 include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lens-less apertures); light detection and ranging sensors; proximity sensors (for example, infrared radiation detector and the like); depth sensors; ambient light sensors; ultrasonic transceivers; and microphones or other like audio capture devices. The communication peripherals 1310 are configured to facilitate communication between the device 1300 and other systems over a communications network and include, for example, a network interface controller, modem, wireless and wired interface cards, antenna, and other communication peripherals. The communication peripherals 1310 can include a digital transmitter having components as described in the previous figures.

### EXAMPLES

In the following sections, further exemplary embodiments are provided.

Example 1 includes a digital transmitter comprising: an antenna; a processing circuitry configured to process and output a signal, wherein the signal is output from the processing circuitry at a first output power within a first dynamic range of the processing circuitry; and a front end module (FEM) coupled with the processing circuitry and the antenna, having a second dynamic range, and configured to amplify the signal for transmission by the antenna at a second output power within the second dynamic range that is larger than the first dynamic range, wherein: the FEM comprises a plurality of power amplifier (PA) stages, each PA stage comprises a PA having a corresponding gain, the plurality of PA stages are switchable based on one or more transmission parameters to provide the second dynamic range, and the one or more transmission parameters include at least one of: the first output power, the second output power, or a modulation and coding scheme (MCS).

Example 2 includes the digital transmitter of example 1, wherein the corresponding gain of a PA stage of the plurality of PA stages is adjustable based on the one or more transmission parameters.

Example 3 includes the digital transmitter of any example 1-2, wherein the processing circuitry comprises a memory storing information indicating a plurality of transmission modes and a selection of one of the plurality of transmission modes based on the one or more transmission parameters, wherein at least two of the plurality of transmission modes correspond to different switching of the plurality of PA stages.

Example 4 includes the digital transmitter of example 3, wherein a first transmission mode of the plurality of transmission modes corresponds to a lower output power of the FEM and a lower PA gain relative to a second transmission mode of the plurality of transmission modes.

Example 5 includes the digital transmitter of any example 1-4, wherein the processing circuitry is further configured to select a transmission mode of the plurality of transmission modes based on the one or more transmission parameters and to send a command to the FEM based on the transmission mode, wherein the plurality of PA stages is controllably switched based on the command.

Example 6 includes the digital transmitter of any example 1-5, wherein a first PA stage of the plurality of PA stages includes semiconductor material different from that of a second PA stage of the plurality of PA stages.

Example 7 includes the digital transmitter of any example 1-6, wherein the FEM further comprises a plurality of attenuator stages coupled at an input of the plurality of PA stages, wherein: each attenuator stage comprises an attenuator having a corresponding gain attenuation, and the plurality of attenuation stages is switchable based on the one or more transmission parameters to provide the second dynamic range.

Example 8 includes the digital transmitter of example 7, wherein the processing circuitry is further configured to select a transmission mode of a plurality of predefined transmission modes based on the second output power and the MCS and to send a command to the FEM based on the transmission mode, wherein each of the plurality of attenuation stages and the plurality of PA stages is controllably switched based on the command.

Example 9 includes the digital transmitter of example 8, wherein the FEM includes a Register 0 (Reg0) that includes a first set of entries associated with the plurality of PA stages and a second set of entries associates with the plurality of attenuation stages, wherein the command includes first bits that indicate a first entry of the first set and second bits that indicate a second entry of the second set, wherein the plurality of PA stages are controllably switched based on the first entry, and wherein the plurality of attenuation stages are controllably switched based on the second entry.

Example 10 includes apparatus comprising: a front end module (FEM) configured to be coupled with a processing circuitry and an antenna of a digital transmitter and to amplify a signal (i) that is output by the processing circuitry at a first output power within a first dynamic range of the processing circuitry and (ii) that is for transmission by the antenna at a second output power within a second dynamic range of the FEM, wherein: the second dynamic range is larger than the first dynamic range, the FEM comprises a plurality of power amplifier (PA) stages, each PA stage comprises a PA having a corresponding gain, the plurality of PA stages are switchable based on one or more transmission parameters to provide the second dynamic range, and the one or more transmission parameters include at least one of: the first output power, the second output power, or a modulation and coding scheme (MCS).

Example 11 includes the apparatus of example 10, further comprising memory storing information indicating that the second dynamic range is divided into a plurality of power segments, wherein each one of the plurality of power segments indicates a corresponding gain step that varies within the first dynamic range.

Example 12 includes the apparatus of example 11, wherein a power segment of the plurality of power segments is selected based on the second output power, and wherein the first output power is set and a configuration of the FEM is selected based on the second output power and the corresponding gain step of the power segment.

Example 13 includes the apparatus of example 12, wherein the FEM further comprises a plurality of attenuator stages coupled at an input of the plurality of PA stages, wherein the configuration of the FEM includes at least one of: a switching of the plurality of PA stages or a switching of the plurality of attenuator stages.

Example 14 includes the apparatus of any example 11-13, wherein at least two of the plurality of power segments have different sizes or a start or an end of a gain step is different between the at least two of the plurality of power segments.

Example 15 includes the apparatus of any example 11-14, wherein the plurality of power segments or corresponding gain steps are based on the MCS.

Example 16 includes the apparatus of any example 11-15, wherein the plurality of power segments, corresponding gain steps, or the first dynamic range are based on an operational temperature or an ambient temperature.

Example 17 includes the apparatus of any example 10-16, wherein the second dynamic range is based on the MCS and is different from another dynamic range of the FEM usable for another MCS.

Example 18 includes the apparatus of any example 10-17, wherein the first dynamic range is based on the MCS and is different from another dynamic range of the processing circuitry usable for another MCS.

Example 19 includes method implemented by a processing circuitry, the method comprising: determining one or more transmission parameters that include at least one of: a first output power within a first dynamic range of the processing circuitry, a second output power within a second dynamic range of a front end module (FEM) coupled with the processing circuitry, or a modulation and coding scheme (MCS), wherein the second dynamic range is larger than the first dynamic range; determining a transmission mode of the FEM based on the one or more transmission parameters, wherein the FEM comprises the FEM comprises a plurality of power amplifier (PA) stages, wherein each PA stage comprises a PA having a corresponding gain, and wherein the plurality of PA stages are switchable based on the transmission mode to provide the second dynamic range; sending a command to the FEM indicating the transmission mode; and outputting, to the FEM, a signal at the first output power.

Example 20 includes the method of example 19, further comprising: determining an attenuation for the FEM based on the one or more transmission parameters, wherein the FEM further comprises a plurality of attenuator stages coupled at an input of the plurality of PA stages, wherein: each attenuator stage comprises an attenuator having a corresponding gain attenuation, and wherein the plurality of attenuation stages are switchable; and indicating the attenuation in the command.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a U E, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1. A digital transmitter comprising:
processing circuitry configured to output a signal at a first output power within a first dynamic range of the processing circuitry; and
a front end module (FEM) coupled with the processing circuitry and an antenna, having a second dynamic range, and configured to amplify the signal for transmission by the antenna at a second output power within the second dynamic range that is larger than the first dynamic range, and comprising a plurality of power amplifier (PA) stages, each PA stage comprising a PA having a corresponding gain, the plurality of PA stages being switchable based on one or more transmission parameters to provide the second dynamic range, and the one or more transmission parameters including at least one of, the first output power, the second output power, or a modulation and coding scheme (MCS).

2. The digital transmitter of claim 1, wherein the corresponding gain of a PA stage of the plurality of PA stages is adjustable based on the one or more transmission parameters.

3. The digital transmitter of claim 1, wherein the processing circuitry comprises a memory storing information indicating a plurality of transmission modes and a selection of one of the plurality of transmission modes based on the one or more transmission parameters, wherein at least two of the plurality of transmission modes correspond to different switching of the plurality of PA stages.

4. The digital transmitter of claim 3, wherein a first transmission mode of the plurality of transmission modes corresponds to a lower output power of the FEM and a lower PA gain relative to a second transmission mode of the plurality of transmission modes.

5. The digital transmitter of claim 3, wherein the processing circuitry is further configured to select a transmission mode of the plurality of transmission modes based on the one or more transmission parameters and to send a command to the FEM based on the transmission mode, wherein the plurality of PA stages is controllably switched based on the command.

6. The digital transmitter of claim 1, wherein a first PA stage of the plurality of PA stages includes semiconductor material different from that of a second PA stage of the plurality of PA stages.

7. The digital transmitter of claim 1, wherein the FEM further comprises a plurality of attenuator stages coupled at an input of the plurality of PA stages, wherein:
each attenuator stage comprises an attenuator having a corresponding gain attenuation; and
the plurality of attenuation stages is switchable based on the one or more transmission parameters to provide the second dynamic range.

8. The digital transmitter of claim 7, wherein the processing circuitry is further configured to select a transmission mode of a plurality of predefined transmission modes based on the second output power and the MCS and to send a command to the FEM based on the transmission mode, wherein each of the plurality of attenuation stages and the plurality of PA stages is controllably switched based on the command.

9. The digital transmitter of claim 8, wherein the FEM includes a Register 0 (Reg0) that includes a first set of entries associated with the plurality of PA stages and a second set of entries associates with the plurality of attenuation stages, wherein the command includes first bits that indicate a first entry of the first set and second bits that indicate a second entry of the second set, wherein the plurality of PA stages are controllably switched based on the first entry, and wherein the plurality of attenuation stages are controllably switched based on the second entry.

10. An apparatus comprising:
an antenna; and
a front end module (FEM) coupled with the antenna and configured to be coupled with processing circuitry of a digital transmitter and to amplify a signal (i) that is output by the processing circuitry at a first output power within a first dynamic range of the processing circuitry and (ii) that is for transmission by the antenna at a second output power within a second dynamic range of the FEM, the second dynamic range being larger than the first dynamic range, the FEM comprising a plurality of power amplifier (PA) stages, each PA stage comprising a PA having a corresponding gain, the plurality of PA stages being switchable based on one or more transmission parameters to provide the second dynamic range, and the one or more transmission parameters including at least one of the first output power, the second output power, or a modulation and coding scheme (MCS).

11. The apparatus of claim 10, further comprising memory storing information indicating that the second dynamic range is divided into a plurality of power segments, wherein each one of the plurality of power segments indicates a corresponding gain step that varies within the first dynamic range.

12. The apparatus of claim 11, wherein a power segment of the plurality of power segments is selected based on the second output power, and wherein the first output power is set and a configuration of the FEM is selected based on the second output power and the corresponding gain step of the power segment.

13. The apparatus of claim 12, wherein the FEM further comprises a plurality of attenuator stages coupled at an input of the plurality of PA stages, wherein the configuration of the FEM includes at least one of a switching of the plurality of PA stages or a switching of the plurality of attenuator stages.

14. The apparatus of claim 11, wherein at least two of the plurality of power segments have different sizes or a start or an end of a gain step is different between the at least two of the plurality of power segments.

15. The apparatus of claim 11, wherein the plurality of power segments or corresponding gain steps are based on the MCS.

16. The apparatus of claim 11, wherein the plurality of power segments, corresponding gain steps, or the first dynamic range are based on an operational temperature or an ambient temperature.

17. The apparatus of claim 10, wherein the second dynamic range is based on the MCS and is different from another dynamic range of the FEM usable for another MCS.

18. The apparatus of claim 10, wherein the first dynamic range is based on the MCS and is different from another dynamic range of the processing circuitry usable for another MCS.

19. A method implemented by processing circuitry, the method comprising:
generating a signal for transmission using one or more transmission parameters that include at least one of a first output power within a first dynamic range of the processing circuitry, a second output power within a second dynamic range of a front end module (FEM) coupled with the processing circuitry, or a modulation and coding scheme (MCS), the second dynamic range being larger than the first dynamic range;
generating, based on the one or more transmission parameters, a command that indicates a transmission mode of the FEM, the FEM comprising a plurality of power amplifier (PA) stages, each PA stage comprising a PA having a corresponding gain, and the plurality of PA stages being switchable based on the transmission mode to provide the second dynamic range;
sending the command to the FEM; and
outputting, to the FEM, the signal at the first output power.

20. The method of claim 19, further comprising:
determining an attenuation for the FEM based on the one or more transmission parameters, wherein the FEM further comprises a plurality of attenuator stages coupled at an input of the plurality of PA stages, wherein each attenuator stage comprises an attenuator having a corresponding gain attenuation, and wherein the plurality of attenuation stages are switchable; and
indicating the attenuation in the command.
